(19) United States
(12) Patent Application Publication
(10) Pub. No.: US 2018/0343964 A1
(43) Pub. Date: Dec. 6, 2018

(54) Techniques for Step Tracking

(71) Applicant: Under Armour, Inc., Baltimore, MD (US)

(72) Inventors: Nathan Dau, Baltimore, MD (US); Angela Nelligan, Baltimore, MD (US); F. Grant Kovach, Baltimore, MD (US); Mark A. Oleson, Baltimore, MD (US)

(21) Appl. No.: 15/607,809

(22) Filed: May 30, 2017

(51) Int. Cl. A43B 3/00; G01C 5/00; G01P 15/08; G01C 22/00; H04W 88/06

(52) U.S. Cl. CPC A43B 3/0005; G01C 5/00; H04W 88/06; G01C 22/006; G01P 15/0888

(57) ABSTRACT

A system includes a shoe, an altimeter, an accelerometer, a processing component, a memory and an output component. The altimeter is disposed at the shoe and detects a first altitude when the shoe is disposed at the first altitude at a first time, detects a second altitude when the shoe is disposed at the second altitude at a second time and generates a detected altitude signal based on a difference between the second altitude and the first altitude. The accelerometer is disposed at the shoe and detects acceleration in a direction of the second altitude and the first altitude and generates a detected acceleration signal. The processing component generates a step count signal based on the detected altitude signal and the detected acceleration signal. The memory stores step count data based on the step count signal. The output component outputs an output signal based on the step count data.

### BACKGROUND

The present invention generally relates to tracking activity.

There exists a need for a device and method to track and count the steps of a person when climbing up and down stairs.

### BRIEF SUMMARY OF THE DRAWINGS

The accompanying drawings, which are incorporated in and form a part of the specification, illustrate example embodiments and, together with the description, serve to explain the principles of the invention. In the drawings:

FIGS. 1A-B illustrate the movement of the legs of a person when walking on flat ground and on stairs;

FIG. 2 illustrates an activity pod in communication with a mobile device in accordance with aspects of the present invention;

FIG. 3 illustrates an activity pod in accordance with aspects of the present invention;

FIG. 4 illustrates a person walking up stairs in accordance with aspects of the present invention; and

FIG. 5 illustrates a process by which steps are counted when a person is going up or down stairs in accordance with aspects of the present invention.

### DETAILED DESCRIPTION

### Overview

A system includes a shoe, an altimeter, an accelerometer, a processing component, a memory and an output component. The altimeter is disposed at the shoe and detects a first altitude when the shoe is disposed at the first altitude at a first time, detects a second altitude when the shoe is disposed at the second altitude at a second time and generates a detected altitude signal based on a difference between the second altitude and the first altitude. The accelerometer is disposed at the shoe and detects acceleration in a direction of the second altitude and the first altitude and generates a detected acceleration signal. The processing component generates a step count signal based on the detected altitude signal and the detected acceleration signal. The memory stores step count data based on the step count signal. The output component outputs an output signal based on the step count data.

### Example Embodiments

One of the recent trends in fitness is tracking steps, both during normal activities and while exercising. Individuals may set goals for themselves regarding the total number of steps they wish to take during the day, and the more steps they take throughout the day, the higher their fitness level tends to be. To track steps, an individual will typically use an activity monitor, which traditionally uses an accelerometer to determine the number of steps a person takes based on the typical motion of a leg while walking or running

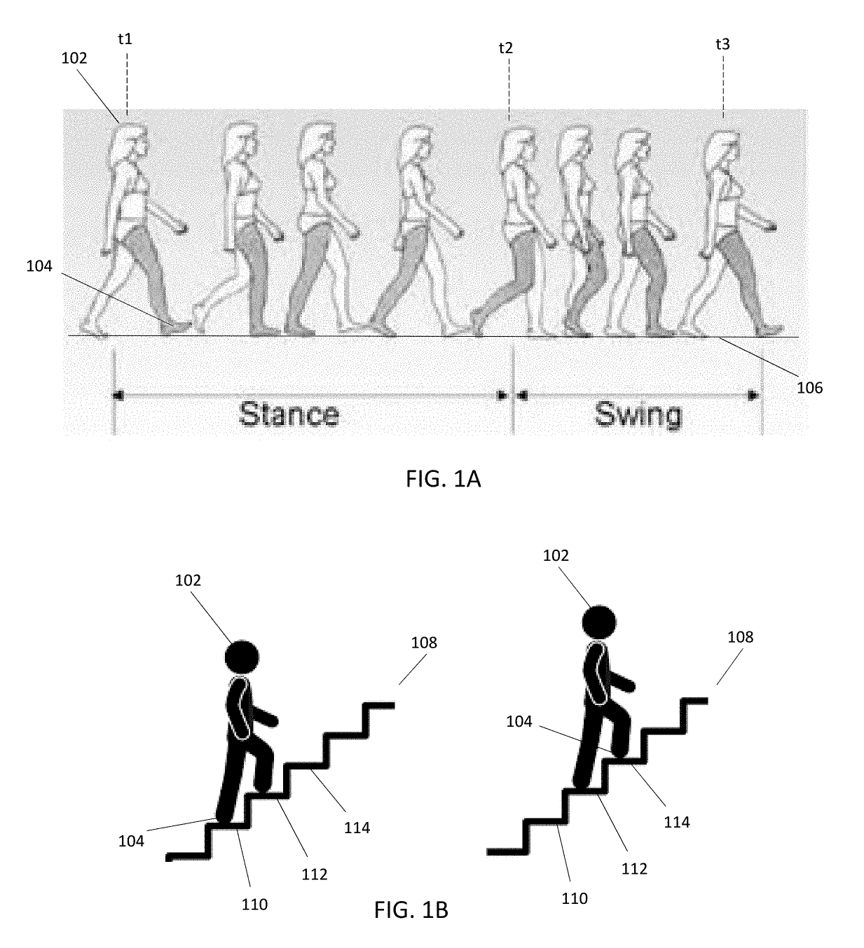

FIGS. 1A-B illustrate the movement of the legs of an athlete when walking on flat ground and on stairs.

As shown in the figures, a person 102 with a foot 104 is walking on a flat surface 106. Between times t₁ and t₂, foot 104 is in contact with surface 106 and moves very little. This is called the stance phase of the walking cycle for foot 104, and it includes all times foot 104 is in contact with surface 106, from when the heel strikes surface 106 until the toe leaves surface 106. Between times t₂ and t₃, foot 104 is not in contact with surface 106 and is swinging to move from behind person 102 to in front of person 102. This is called the swing phase of the walking cycle for foot 104, and it includes all times foot 104 is not in contact with surface 106, from when the toe leaves surface 106 until the heel strikes surface 106.

If person 102 desires to count her steps, she may wear a shoe equipped with an activity monitor. A traditional activity monitor would determine how many steps person 102 took by measuring the amount of horizontal acceleration of foot 104 during the walk. During the stance phase of walking the activity monitor may register little to no acceleration, but during the swing phase of walking the activity monitor will register acceleration while the foot is in motion. When the foot once again hits the ground to start the stance phase, the activity monitor will register little to no acceleration. When the accelerometer detects a period of horizontal acceleration in between periods of little to no acceleration, the detected horizontal acceleration will be counted as one step. The process of counting steps will continue until person 102 ends her walk. In other words, a conventional activity monitor counts steps based on a detected acceleration parallel to surface 106, which is likely detected while foot 104 is swinging from the position at time t₂ to the position at time t₃. However, this swing motion is not as accentuated when person 102 traverses a flight of stairs.

If, during the walk, person 102 encounters a set of stairs 108 that includes a plurality of steps, a sample of which are indicated as a step 110, a step 112 and a step 114, a conventional activity monitor may not register the movement of foot 104 appropriately. When walking on stairs 108, the stance and swing phases of a typical walking cycle are interrupted. To move foot 104 from step 110 to step 114, person 102 must lift foot 104 up from step 110 while pushing up with her opposite foot. Person 102 lifts and extends foot 104 until it is above step 114, then lowers foot 104 until it contacts step 114.

The swing motion of the foot is not as accentuated when climbing a stair as opposed to when walking on flat ground. As compared with walking on surface 106, the action of walking up or down stairs 108 will register much lower horizontal acceleration levels. Accordingly, a conventional activity tracker may not record the lower horizontal acceleration levels as steps. As a result, the data on the number of steps taken by person 102 may not accurately reflect the total number of steps taken. This can also pose a problem for people engaging in workouts that include running up and down stairs.

There exists a need for a system that can accurately track steps when going up or down stairs. In accordance with aspects of the present invention a system including a shoe with a shoe pod associated therewith will count steps based on a change in height as measured with an altimeter in conjunction with measured acceleration in the direction of the change in height. In this manner, the motion of rising up (or lowering down) the foot by a step is accurately measured without considering any inaccurate contributions of swing motions of the foot.

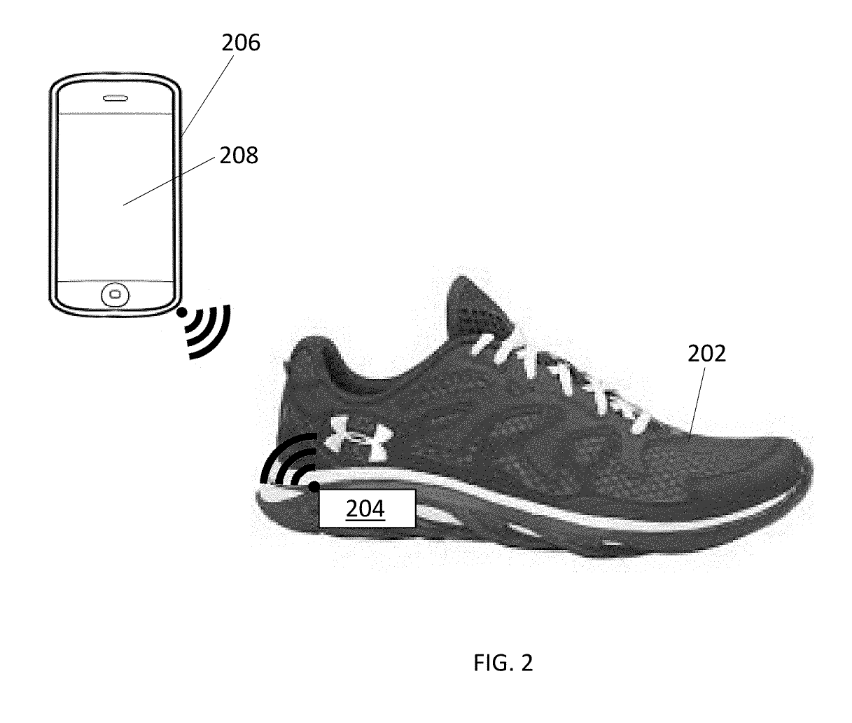

A system to better measure vertical motion will be described with reference to FIG. 2.

FIG. 2 illustrates an activity pod in communication with a mobile device, in accordance with aspects of the present invention.

As shown in the figure, a shoe 202 includes an activity pod 204, and a mobile device 206 includes a display 208.

Shoe 202 may be any type of athletic shoe adapted to receive activity pod 204 or any other type of activity tracking device. Activity pod 204 may be any type of device or system that can detect the magnitude and direction of acceleration of an object, and change in altitude of an object.

Activity pod 204 may be included in the sole of shoe 202, however it may also be included in other locations within shoe 202 that still allow activity pod 204 to measure the acceleration and altitude of shoe 202.

Mobile device 206 may be any type of device or system that can wirelessly communicate with activity pod 204. Non-limiting examples of mobile device 206 include cellular phones, smartphones, fitness trackers, tablet computers and laptop computers. Non-limiting examples of ways in which mobile device 206 and activity pod 204 may communicate wirelessly include WiFi, cellular network, Bluetooth and radio frequency.

Display 208 may be any type of device that can display information on mobile device 206. A non-limiting example of display 208 is a touchscreen.

In the example embodiment discussed above, activity pod 204 is included within shoe 202. In other embodiments, activity pod 204 is a separate component that may be detachably fastened to shoe 202 by any known manner, non-limiting examples of which include adhesives, latch-and-hook materials, laces, clips and combinations thereof.

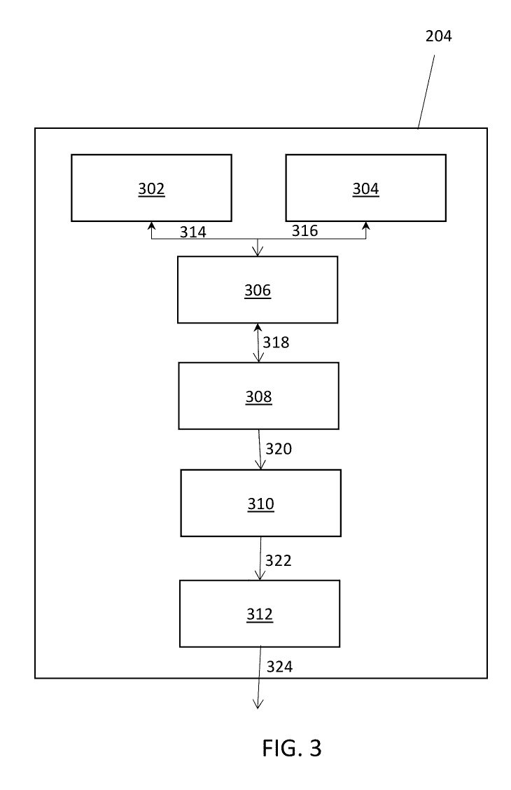

FIG. 3 illustrates an activity pod in accordance with aspects of the present invention.

As shown in the figure, activity pod 204 includes an altimeter 302, an accelerometer 304, a processing component 306, a memory 308, an output component 310 and a communication component 312.

In this example embodiment, altimeter 302, accelerometer 304, processing component 306, memory 308, output component 310 and communication component 312 are shown as independent components. However, in some embodiments, at least two of altimeter 302, accelerometer 304, processing component 306, memory 308, output component 310 and communication component 312 may be combined as a unitary component. Further, in some embodiments, at least one of altimeter 302, accelerometer 304, processing component 306, memory 308, output component 310 and communication component 312 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Altimeter 302 communicates with processing component 306 via communication channel 314. Altimeter 302 may be any type of device or system that detects the altitude or changes in altitude of activity pod 204.

Accelerometer 304 communicates with processing component 306 via communication channel 316. Accelerometer 304 may be any type of device or system that detects the acceleration or changes in acceleration of activity pod 204.

Processing component 306 communicates with altimeter 302 via communication channel 314, with accelerometer 304 via communication channel 316, and with memory 308 via communication channel 318.

Processing component 306 may be any type of device or system that receives data from altimeter 302 and accelerometer 304, analyzes the data and provides the analyzed data to memory 308.

Memory 308 communicates with processing component 306 via communication channel 318 and with output component 310 via communication channel 320.

Memory 308 may be any device or system that stores data provided by processing component 306 and provides the data to output component 310 when needed. Non-limiting examples of memory include: physical storage and/or memory media such as RAM, ROM, EEPROM, CD-ROM or other optical disk storage, magnetic disk storage or other magnetic storage devices.

Output component 310 communicates with memory 308 via communication channel 320 and with communication component 312 via communication channel 322. Output component 310 may be any device or system that receives data from memory 308 and provides the data to communication component 312.

Communication component 312 communicates with output component 310 via communication channel 322 and with mobile device 206 via communication channel 324.

Communication component 312 may be any device or system that receives data from output component 310 and provides the data to mobile device 206 to display to a user via display 208.

Communication channels 314, 316, 318, 320, 322 and 324 may be any type of conventional communication channel that would facilitate communication between components or devices. Non-limiting examples of communication channels 314, 316, 318, 320, 322 and 324 include wired connections, WiFi, Bluetooth, cellular network and radio frequency.

In the system described above, the activity pod includes altimeter 302, accelerometer 304, processing component 306, memory 308 and output component 310. However, in some embodiments, altimeter 302, accelerometer 304, processing component 306, memory 308 and output component 310 may be included in mobile device 206. In such embodiments, an activity pod is not required to record activity as long as the person secures the mobile device to himself in a location that enables accurate detection of acceleration and altitude.

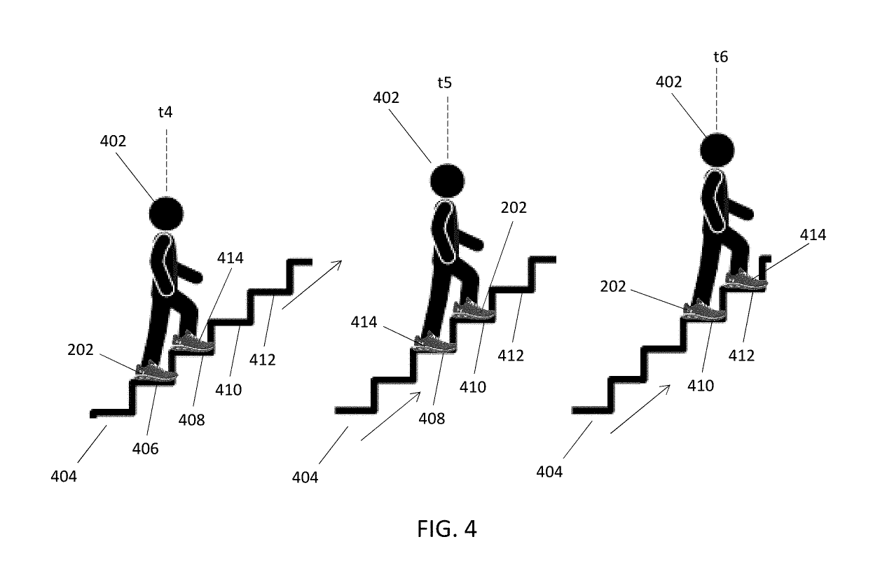

FIG. 4 illustrates a person walking up stairs in accordance with aspects of the present invention.

As shown in the figure, a person 402 is walking up a staircase 404 while wearing shoe 202 and a shoe 414. Staircase 404 further includes a step 406, a step 408, a step 410, and a step 412.

Shoe 414 may be equivalent to shoe 202, in that shoe 414 may also contain an activity pod 204 to track the activity of shoe 414. However, shoe 414 may be a standard shoe that does not include activity pod 204. In such cases where one activity pod 204 is utilized, total activity data may be modified to account for undetected steps. For example, if an activity pod 204 in a single shoe 202 detects two thousand steps, the activity pod 204 may double the step count to four thousand steps to account for the other shoe it was not detecting during that time.

At time t₄, shoe 202 is on step 406 and shoe 414 is on step 408. As person 402 continues to climb staircase 404, at time t₅, shoe 202 moved to step 410. At time t₆, shoe 414 moved to step 412.

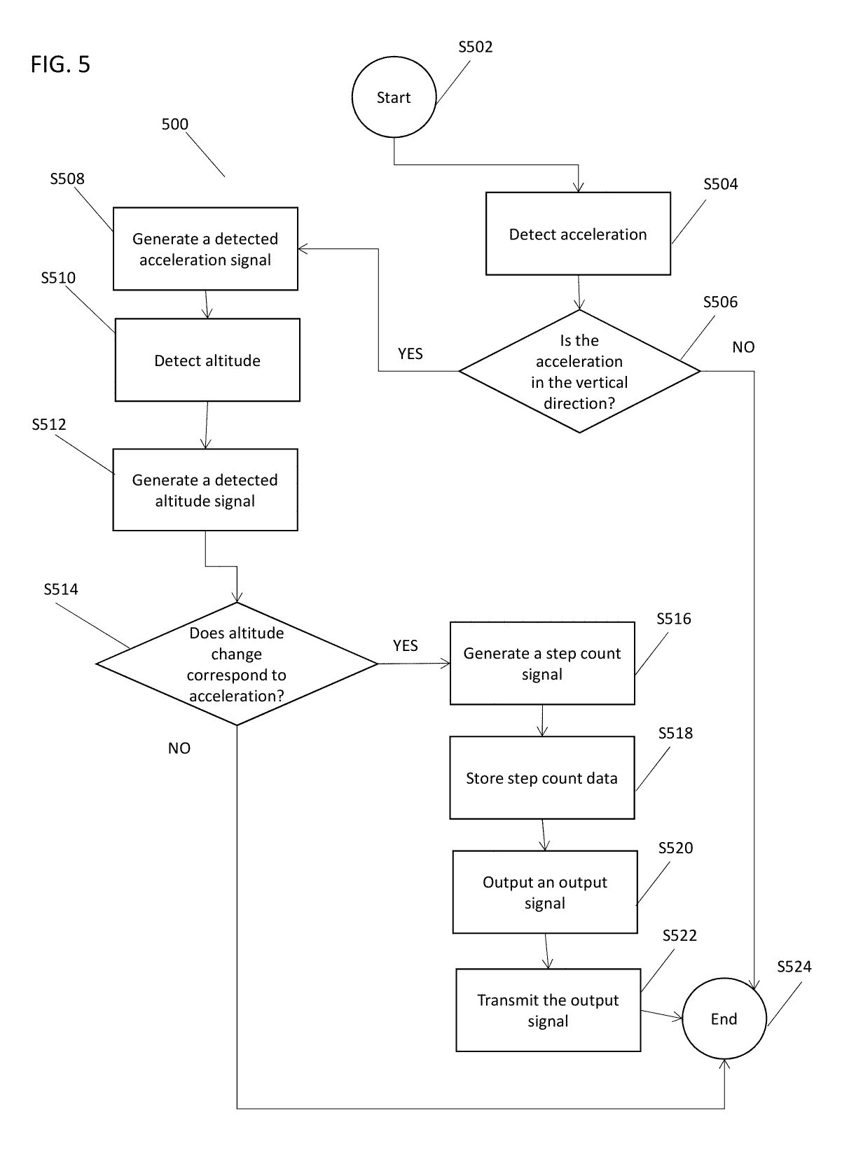

The process by which activity pod 204 measures steps will be further described with reference to FIG. 5.

FIG. 5 illustrates a process by which steps are counted when a person is going up or down stairs in accordance with aspects of the present invention.

As shown in the figure, process 500 starts (S502) and acceleration is detected (S504).

Returning to FIG. 4, between t₄ and t₅, person 402 moves shoe 202 from step 406 to step 410. Referring to FIG. 3, when shoe 202 moves from step 406 to step 410, activity pod 204 also moves, and accelerometer 304 detects this movement as a change in acceleration.

Returning to FIG. 5, after acceleration is detected (S504) the system determines if the acceleration is in the vertical direction (S506).

In some instances, a person may be walking on flat ground, and accelerometer 304 may only detect acceleration in the horizontal direction that corresponds to the typical stance and swing phases of the walking cycle. In such instances the acceleration detected by accelerometer 304 is not in the vertical direction (NO at S506), and process 500 ends (S524).

Returning to FIG. 4, person 402 must lift shoe 202 in the vertical direction to move shoe 202 from step 406 to step 410. As a result, and with reference to FIG. 3, accelerometer 304 detects acceleration in the vertical direction (YES at S506). Accelerometer 304 can detect acceleration in the positive or negative vertical directions, so a vertical acceleration would register with accelerometer 304 if person 402 were walking up or down staircase 404.

Referring back to FIG. 5, if it is determined that the detected acceleration is in the vertical direction (YES at S506), a detected acceleration signal is generated (S508).

Returning to FIG. 3, when accelerometer 304 detects acceleration in the upward vertical direction, accelerometer 304 generates a signal corresponding to the detected acceleration.

For example, and with reference to FIG. 4, if person 402 is running, the acceleration signal generated may indicate that shoe 202 accelerated in the upward vertical direction at a magnitude indicative of running If, for example, person 402 is walking, the acceleration signal generated may indicate that shoe 202 accelerated in the upward vertical direction at a magnitude indicative of walking.

Returning to FIG. 5, after the detected acceleration signal is generated (S508), altitude is detected (S510).

Returning to FIG. 4, person 402 must lift shoe 202 in the vertical direction to move shoe 202 from step 406 to step 410. As a result, and with reference to FIG. 3, altimeter 302 detects an altitude change equal to the vertical distance between step 406 and step 410. Altimeter 302 can detect altitude changes in the positive or negative vertical directions, so a vertical altitude change would register with altimeter 302 if person 402 were walking up or down staircase 404.

Referring to FIG. 5, after the altitude is detected (S510), a detected altitude signal is generated (S512).

Returning to FIG. 3, when altimeter 302 detects an altitude change, altimeter 302 generates a signal corresponding to the detected altitude change.

For example, and with reference to FIG. 4, when shoe 202 moves from step 406 to step 410, the detected altitude signal may indicate the difference in altitude between step 406 and step 410. If, for example, the height of each step is eight inches, the detected altitude signal will indicate that the altitude of shoe 202 increased by sixteen inches in moving from step 406 to step 410.

Returning to FIG. 5, after the detected altitude signal is generated (S512), the system determines if the altitude change corresponds to the direction of the acceleration (S514).

In some instances, a person may be walking on flat ground, but the person may lift his feet high off the ground when walking. In such instances, accelerometer 304 may detect a vertical acceleration. However, altimeter 302 will not detect a net change in altitude because the shoe the person is wearing returns to the flat ground with each step. In such cases, the change in altitude does not correspond with the change in acceleration (NO at S514), so the system will not count the person's activity as walking up or down steps, and process 500 ends (S524).

Returning to FIG. 4, when person 402 lifts shoe 202 from step 406 to step 410, accelerometer 304 detects acceleration in the upward direction, and altimeter 302 detects a change in altitude in the upward direction. Therefore, the change in altitude corresponds to the change in acceleration (YES at S514), and then a step count signal is generated (S516).

Returning to FIG. 3, accelerometer 304 provides the detected acceleration signal to processing component 306, and altimeter 302 provides the detected altitude signal to processing component 306. Processing component analyzes the signals and generates a step count signal.

In some embodiments, and with reference to FIG. 4, the change in altitude may correspond to person 402 climbing staircase 404 one step at a time, and the acceleration may correspond to person 402 walking. In this case, processing component 306 may generate a step count signal that corresponds to person 402 walking up staircase 404.

In other embodiments, the change in altitude may correspond to person 402 climbing staircase 404 one step at a time, and the acceleration may correspond to person 402 running. In this case, processing component 306 may generate a step count signal that corresponds to person 402 running up staircase 404.

In other embodiments, the change in altitude may correspond to person 402 climbing staircase 404 two or more steps at a time, and the acceleration may correspond to person 402 running In this case, processing component 306 may generate a step count signal that corresponds to person 402 skipping steps while running up staircase 404.

In some embodiments, the step count signal may be generated by updating the signal with each additional step taken by person 402. In other embodiments, the step count signal may be generated by comparing the initial altitude to the final altitude, and calculating the number of steps based on the average step height.

Returning to FIG. 5, after the step count signal is generated (S516), the step count data is stored (S518).

Referring to FIG. 3, processing component provides the step count data to memory 308.

Non-limiting examples of step count data stored by memory 308 include the total number of steps climbed, step climbing speed, step height, and combinations thereof.

Returning to FIG. 5, after the step count data is stored (S518), an output signal is outputted (S520).

Referring to FIG. 3, output component 310 receives the step count data stored by memory 308 and generates an output signal based on the step count data.

Non-limiting examples of data included in the output signal include the total number of steps climbed in a single day, total number of steps climbed over a plurality of days, average number of steps climbed per day, step climbing speed in a single day, average step climbing speed over a plurality of days, step height in a single day, average step height over a plurality of days, total altitude in a single day, and total altitude over a plurality of days.

Returning to FIG. 5, after the output signal is output (S520), the output signal is transmitted (S522).

Referring to FIG. 3, output component 310 sends the output signal to communication component 312, and communication component 312 sends the output signal to display 208 on mobile device 206.

To transmit the output signal from communication component 312 to mobile device 206, it is necessary for activity pod 204 to connect to mobile device 206. Activity pod 204 and mobile device 206 may initiate a connection via any type of conventional connection means, including a handshake. Once the connection is secured, the output signal can be transmitted from communication component 312 to mobile device 206.

Returning to FIG. 4, when person 402 finishes walking, he may desire to view his step count data, and more specifically how many stairs he climbed and how far he traveled in the vertical direction. To do so, he may access the data via mobile device 206 and view the data via display 208.

Returning to FIG. 5, after the output signal is transmitted (S522), process 500 ends (S524).

In summary, the present invention provides a device and method to eliminate the problems conventional step counting devices have with registering steps when climbing stairs. In combining and comparing data generated from an accelerometer and an altimeter, the present invention can determine when a person is walking up or down stairs, and can count the steps, and the change in altitude, of the person while walking up or down stairs.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A system for use by a user, said system comprising:
a shoe to be worn by the user;
an altimeter disposed at said shoe and operable to detect a first altitude when said shoe is disposed at the first altitude at a first time, to detect a second altitude when said shoe is disposed at the second altitude at a second time and to generate a detected altitude signal based on a difference between the second altitude and the first altitude;
an accelerometer disposed at said shoe and operable to detect acceleration in a direction of the second altitude and the first altitude and to generate a detected acceleration signal;
a processing component operable to generate a step count signal based on the detected altitude signal and the detected acceleration signal;
a memory operable to store step count data based on the step count signal; and
an output component operable to output an output signal based on the step count data.

2. The system of claim 1, further comprising a communication component operable to wirelessly transmit the output signal.

3. The system of claim 2, wherein said memory is disposed at said shoe.

4. The system of claim 3,
wherein said altimeter is further operable to detect a third altitude when said shoe is disposed at the third altitude at a third time and to generate a second detected altitude signal based on a difference between the third altitude and the second altitude,
wherein said accelerometer is further operable to detect acceleration in a direction of the third altitude and the second altitude and to generate a second detected acceleration signal,
wherein said processing component is further operable to generate a second step count signal based on the second detected altitude signal and the second detected acceleration signal,
a memory operable to modify the step count data based on the second step count signal, and
wherein said output component is further operable to output the output signal based on the modified step count data.

5. The system of claim 3,
wherein said altimeter is further operable to detect a third altitude when said shoe is disposed at the third altitude at a third time and to generate a second detected altitude signal based on a difference between the third altitude and the first altitude,
wherein said accelerometer is further operable to detect acceleration in a direction of the third altitude and the first altitude and to generate a second detected acceleration signal,
wherein said processing component is further operable to generate a second step count signal based on the second detected altitude signal and the second detected acceleration signal, and
a memory operable rewrite the step count data based on the second step count signal.

6. The system of claim 1,
wherein said altimeter is further operable to detect a third altitude when said shoe is disposed at the third altitude at a third time and to generate a second detected altitude signal based on a difference between the third altitude and the second altitude,
wherein said accelerometer is further operable to detect acceleration in a direction of the third altitude and the second altitude and to generate a second detected acceleration signal,
wherein said processing component is further operable to generate a second step count signal based on the second detected altitude signal and the second detected acceleration signal,
a memory operable to modify the step count data based on the second step count signal, and
wherein said output component is further operable to output the output signal based on the modified step count data.

7. The system of claim 1,
wherein said altimeter is further operable to detect a third altitude when said shoe is disposed at the third altitude at a third time and to generate a second detected altitude signal based on a difference between the third altitude and the first altitude,
wherein said accelerometer is further operable to detect acceleration in a direction of the third altitude and the first altitude and to generate a second detected acceleration signal,
wherein said processing component is further operable to generate a second step count signal based on the second detected altitude signal and the second detected acceleration signal, and
a memory operable rewrite the step count data based on the second step count signal.

8. A method comprising:
detecting, via an altimeter disposed at a shoe, a first altitude when the shoe is disposed at the first altitude at a first time;
detecting, via the altimeter, a second altitude when the shoe is disposed at the second altitude at a second time;
generating, via the altimeter, a detected altitude signal based on a difference between the second altitude and the first altitude;
detecting, via an accelerometer disposed at the shoe, detect acceleration in a direction of the second altitude and the first altitude;
generating, via the accelerometer, a detected acceleration signal;
generating, via a processing component, a step count signal based on the detected altitude signal and the detected acceleration signal;
storing, into a memory, step count data based on the step count signal; and
outputting, via an output component, an output signal based on the step count data.

9. The method of claim 8, further comprising wirelessly transmitting, via a communication component, the output signal.

10. The method of claim 9, wherein said storing step count data comprises storing into the memory disposed at the shoe.

11. The method of claim 10, further comprising:
detecting, via the altimeter, a third altitude when the shoe is disposed at the third altitude at a third time;
generating, via the altimeter, a second detected altitude signal based on a difference between the third altitude and the second altitude;
detecting, via the accelerometer, acceleration in a direction of the third altitude and the second altitude;
generating, via the accelerometer, a second detected acceleration signal;
generating, via the processing component, a second step count signal based on the second detected altitude signal and the second detected acceleration signal;
modifying, via the memory, the step count data based on the second step count signal; and
outputting, via the output component, the output signal based on the modified step count data.

12. The method of claim 10, further comprising:
detecting, via the altimeter, a third altitude when the shoe is disposed at the third altitude at a third time;
generating, via the altimeter, a second detected altitude signal based on a difference between the third altitude and the first altitude;
detecting, via the accelerometer, acceleration in a direction of the third altitude and the first altitude;
generating, via the accelerometer, a second detected acceleration signal;
generating, via the processing component, a second step count signal based on the second detected altitude signal and the second detected acceleration signal;
rewriting, via the memory, the step count data based on the second step count signal.

13. The method of claim 8, further comprising:
detecting, via the altimeter, a third altitude when the shoe is disposed at the third altitude at a third time;
generating, via the altimeter, a second detected altitude signal based on a difference between the third altitude and the second altitude;
detecting, via the accelerometer, acceleration in a direction of the third altitude and the second altitude;
generating, via the accelerometer, a second detected acceleration signal;
generating, via the processing component, a second step count signal based on the second detected altitude signal and the second detected acceleration signal;
modifying, via the memory, the step count data based on the second step count signal; and
outputting, via the output component, the output signal based on the modified step count data.

14. The method of claim 8, further comprising:
detecting, via the altimeter, a third altitude when the shoe is disposed at the third altitude at a third time;
generating, via the altimeter, a second detected altitude signal based on a difference between the third altitude and the first altitude;
detecting, via the accelerometer, acceleration in a direction of the third altitude and the first altitude;
generating, via the accelerometer, a second detected acceleration signal;
generating, via the processing component, a second step count signal based on the second detected altitude signal and the second detected acceleration signal;
rewriting, via the memory, the step count data based on the second step count signal.

15. A non-transitory, tangible, computer-readable media having computer-readable instructions stored thereon, the computer-readable instructions being capable of being read by a computer and being capable of instructing the computer to perform the method comprising:
detecting, via an altimeter disposed at a shoe, a first altitude when the shoe is disposed at the first altitude at a first time;
detecting, via the altimeter, a second altitude when the shoe is disposed at the second altitude at a second time;
generating, via the altimeter, a detected altitude signal based on a difference between the second altitude and the first altitude;
detecting, via an accelerometer disposed at the shoe, detect acceleration in a direction of the second altitude and the first altitude;
generating, via the accelerometer, a detected acceleration signal;
generating, via a processing component, a step count signal based on the detected altitude signal and the detected acceleration signal;
storing, into a memory, step count data based on the step count signal; and
outputting, via an output component, an output signal based on the step count data.

16. The non-transitory, tangible, computer-readable media of claim 15, the computer-readable instructions being capable of being read by a computer and being capable of instructing the computer to perform the method further comprising wirelessly transmitting, via a communication component, the output signal.

17. The non-transitory, tangible, computer-readable media of claim 16, wherein said storing step count data comprises storing into the memory disposed at the shoe.

18. The non-transitory, tangible, computer-readable media of claim 15, the computer-readable instructions being capable of being read by a computer and being capable of instructing the computer to perform the method further comprising, further comprising:
detecting, via the altimeter, a third altitude when the shoe is disposed at the third altitude at a third time;
generating, via the altimeter, a second detected altitude signal based on a difference between the third altitude and the second altitude;
detecting, via the accelerometer, acceleration in a direction of the third altitude and the second altitude;
generating, via the accelerometer, a second detected acceleration signal;
generating, via the processing component, a second step count signal based on the second detected altitude signal and the second detected acceleration signal;
modifying, via the memory, the step count data based on the second step count signal; and
outputting, via the output component, the output signal based on the modified step count data.

19. The non-transitory, tangible, computer-readable media of claim 15, the computer-readable instructions being capable of being read by a computer and being capable of instructing the computer to perform the method further comprising, further comprising:
detecting, via the altimeter, a third altitude when the shoe is disposed at the third altitude at a third time;
generating, via the altimeter, a second detected altitude signal based on a difference between the third altitude and the first altitude;
detecting, via the accelerometer, acceleration in a direction of the third altitude and the first altitude;
generating, via the accelerometer, a second detected acceleration signal;
generating, via the processing component, a second step count signal based on the second detected altitude signal and the second detected acceleration signal;
rewriting, via the memory, the step count data based on the second step count signal.

20. The non-transitory, tangible, computer-readable media of claim 15, the computer-readable instructions being capable of being read by a computer and being capable of instructing the computer to perform the method further comprising, further comprising:
detecting, via the altimeter, a third altitude when the shoe is disposed at the third altitude at a third time;
generating, via the altimeter, a second detected altitude signal based on a difference between the third altitude and the second altitude;
detecting, via the accelerometer, acceleration in a direction of the third altitude and the second altitude;
generating, via the accelerometer, a second detected acceleration signal;
generating, via the processing component, a second step count signal based on the second detected altitude signal and the second detected acceleration signal;
modifying, via the memory, the step count data based on the second step count signal; and
outputting, via the output component, the output signal based on the modified step count data.
